(19) United States
(12) Patent Application Publication
(10) Pub. No.: US 2007/0245017 A1
(43) Pub. Date: Oct. 18, 2007

(54) Push service system and information acquisition terminal

(75) Inventor: Tatsuya Shintai, Chita-gun (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/732,474

(22) Filed: Apr. 3, 2007

(30) Foreign Application Priority Data
Apr. 18, 2006 (JP) 2006-114893

(51) Int. Cl. G06F 15/16; G06F 15/173

(52) U.S. Cl. 709/224; 709/203

(57) ABSTRACT

A push service system and a terminal used in the system are operated according to a following operation scheme of information transmission. The terminal sends to a host in the system a request for re-transmission of information through a communication network when the terminal returns to a waiting condition from a non-waiting condition. Upon receiving the request, the host requests the communication network to re-transmit the information to the terminal. A non-waiting condition continuation time as a criterion for determining continuation of the non-waiting condition of the terminal is substantially matched with a re-transmission time of the information from the communication network to the terminal for controlling the re-transmission of the information.

### CROSS REFERENCE TO RELATED APPLICATION

This application is based on and claims the benefit of priority of Japanese Patent Application No. 2006-114893 filed on Apr. 18, 2006, the disclosure of which is incorporated herein by reference.

### FIELD OF THE INVENTION

The present invention generally relates to a push service system and apparatus used therein.

### BACKGROUND INFORMATION

Japanese patent document No. JP-A-2003-288298 describes a general construction example of the conventional information provision system that is connected to a leased line or the Internet and provides a push service. FIG. 1 shows the system construction. The system includes: an information acquisition terminal A 101 and an information acquisition terminal B 102 connected to a wireless communication network 104; an information acquisition terminal C 103 not connected to the wireless communication network 104; an information provision host 106 connected to a wired communication network 107 (specifically a leased line or the Internet); and an access server 105 for connecting the wireless communication network 104 with the wired communication network 107.

Let us consider that the information provision host 106 provides information to the information acquisition terminals A 101, B 102, and C 103. The information provision host 106 uni-directionally transmits information to these terminals independently of whether or not they are connected to the wireless communication network 104. In such case, the information acquisition terminals A 101 and B 102 are connected to the wireless communication network 104 and can receive the information provided from the information provision host 106.

However, the information acquisition terminal C 103 is not connected to the wireless communication network 104 and cannot receive the information provided from the information provision host 106.

As mentioned above, the push service aims at providing information to the information acquisition terminal. The push service allows the information provision host to provide information to the information acquisition terminal without obliging an information acquisition terminal user to explicitly accessing the information provision host. The information denotes various content information needed by users and is hereafter referred to as push service information.

The push service allows the information provision host to unilaterally provide push service information independently of whether or not an information acquisition terminal requiring the push service information is capable of wireless communication. When the information acquisition terminal is not connected to the wireless communication network (hereafter referred to as being out of wireless communication service), that terminal cannot receive push service information transmitted from the information provision host according to the technology in FIG. 1. The user at least needs to always connect the information acquisition terminal to the wireless communication network so as to be able to receive necessary push service information.

There may be provided conversation unit for establishing a voice call between information acquisition terminals. Some information acquisition terminals are simultaneously capable of conversation and data communication compatible with W-CDMA (Wideband Code Division Multiple Access), for example. The other information acquisition terminals generally share a channel for the push service and a channel for the conversation so as to connect to the wireless communication network. In this case, it is impossible to simultaneously carry on a conversation and provide the push service. While the information acquisition terminal is using the conversation function, the terminal cannot receive push service information from the information provision host similarly to the state being out of wireless communication service.

In this manner, the information acquisition terminal may not be able to receive push service information at a time it is provided. In general, the access server periodically retransmits the push service information to the information acquisition terminal for a specified time period. After lapse of the specified time period, the access server stops the retransmission and notifies the information provision host of unsuccessful transmission. In response to this notification, the information provision host provides the known retransmission control and requests the access server to retransmit the push service information to the information acquisition terminal.

However, the system is subject to problems as shown in FIGS. 2 and 3. FIG. 2 assumes that push service information is transmitted when an information acquisition terminal is out of wireless communication service. FIG. 3 assumes that push service information is transmitted while an information acquisition terminal is carrying on a conversation.

When the information acquisition terminal is out of wireless communication service in FIG. 2, the access server finishes transmitting the push service information after a specified time period and notifies the information provision host of unsuccessful transmission. While the information provision host controls retransmission of the push service information, the information acquisition terminal may move to temporarily become in service (a state capable of wireless communication), and then move to a region where no wireless communication service is available. In such case, the access server thereafter receives a transmission request under retransmission control of the information provision host and retransmits the push service information. The information acquisition terminal nevertheless cannot receive the retransmitted push service information. The information provision host is necessitated to provide the retransmission control. The retransmission under the retransmission control causes an unnecessary communication traffic. The same applies to a situation where the information acquisition terminal carries on a conversation, disables it in wireless communication service (hereafter referred to as standby), and then restarts the conversation or becomes out of wireless communication service (FIG. 3).

### SUMMARY OF THE INVENTION

In view of the above and other problems, the present invention provides a push system and terminal that prevents unnecessary communication traffic between a terminal and a host in a communication network.

The push service system of the present disclosure includes a terminal for acquiring information when wireless communication is established between the terminal and a communication network and a host for providing information for the terminal regardless of a condition of wireless communication of the terminal. The terminal requests the host through the wireless communication to provide the information when the terminal resumes the wireless communication after a predetermined period of lack of wireless communication with the communication network. In this manner, the retransmission of the information to the terminal is provided only when the re-transmission is explicitly requested from the terminal that has returned to a wireless communication service area after a predetermined time of non-serviceable condition, thereby preventing unnecessary communication traffic.

The operation scheme of the host and the terminal in the push service system may be described as a function of a terminal side. Further, the operation scheme may be described as alternation of a voice call and data communication, and accordingly the function of the terminal side.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a conventional push service system;

FIG. 2 shows a sequence chart of information re-transmission in the conventional push service system;

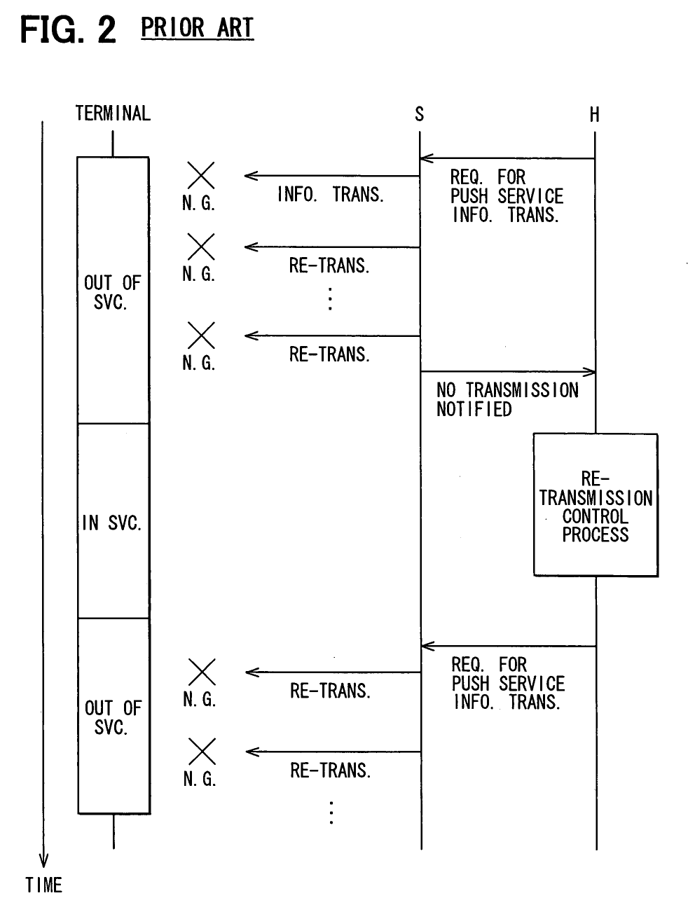

FIG. 3 shows another sequence chart of information re-transmission in the conventional push service system;

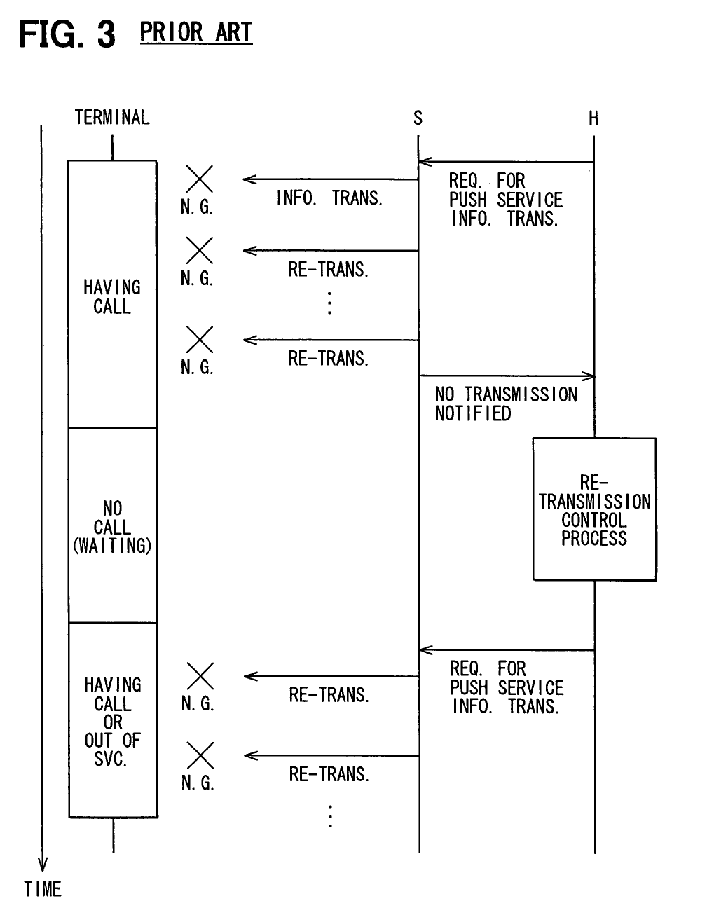

FIG. 4 show a block diagram of a push service system and a terminal in an embodiment of the present disclosure;

FIG. 5 shows a flowchart of data transmission process of the push service system and the terminal in the embodiment;

FIG. 6 shows a sequence chart of information re-transmission in the push service system in the embodiment of the present disclosure; and

FIG. 7 shows another sequence chart of information re-transmission in the push service system in the embodiment of the present disclosure.

### DETAILED DESCRIPTION

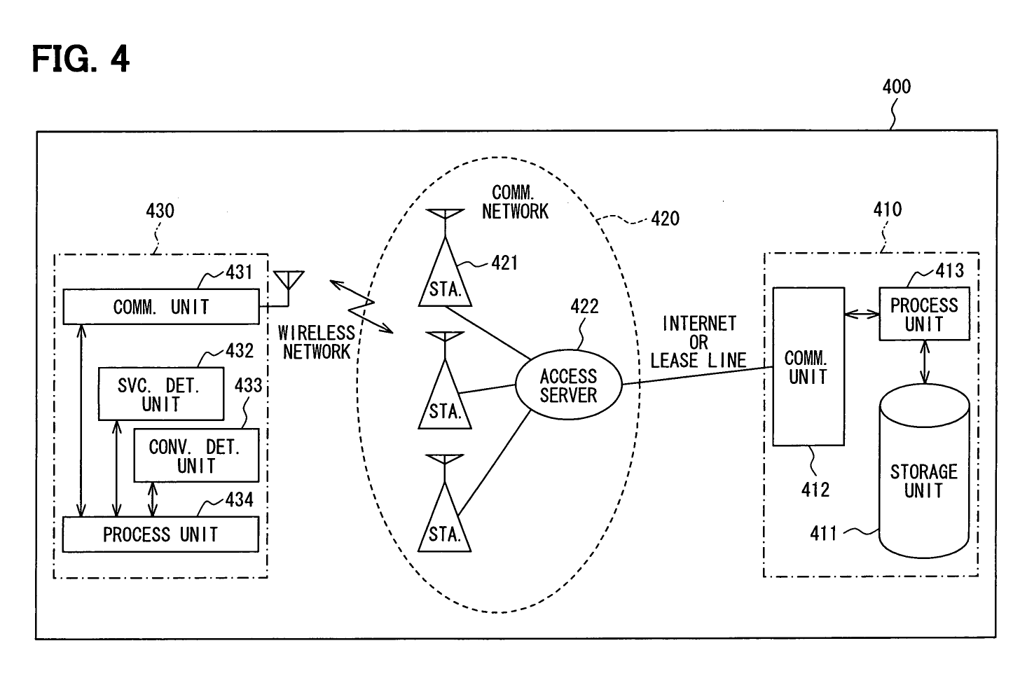

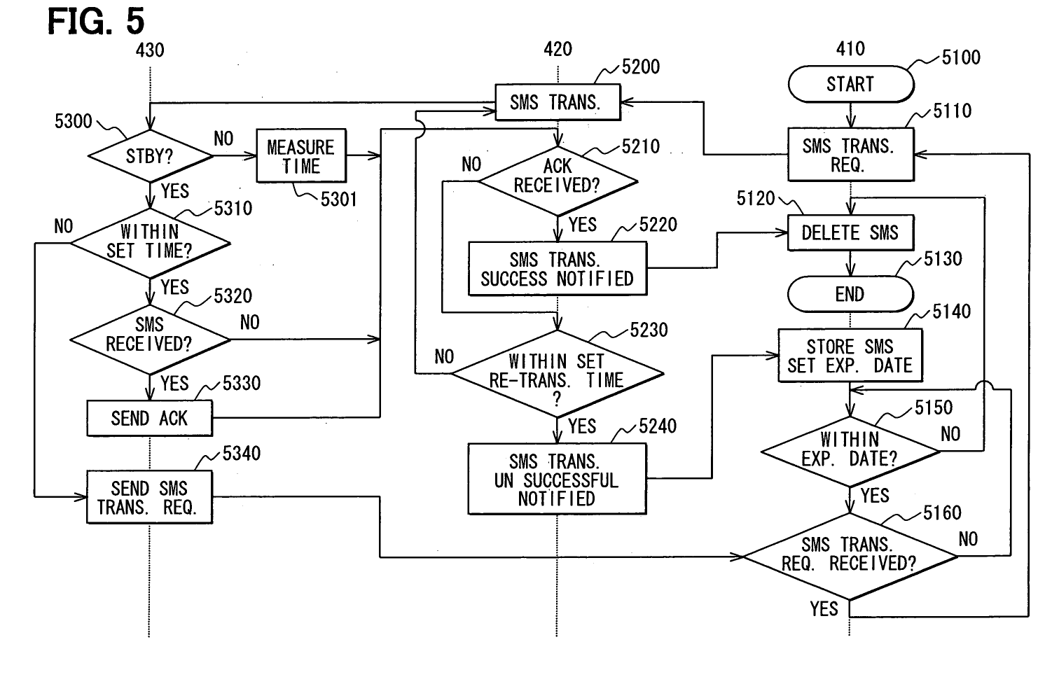

An embodiment of the invention will be described in further detail with reference to FIGS. 4 and 5. FIG. 4 schematically shows the construction of a push service system and an information acquisition terminal according to the invention. A push service system 400 according to the invention includes: an information provision host 410 that maintains push service information and provides a push service; a communication network 420 that is connected to the information provision host 410 via wired communication such as a leased line or the Internet and relays the push service information; an information acquisition terminal 430 that is connected to the communication network 420 via wireless communication and receives the push service information. More specifically, the information provision host 410 is equivalent to a push service provider's information distribution center. The communication network 420 is equivalent to a communication network managed by a telecommunications carrier. The information acquisition terminal 430 is equivalent to a mobile phone owned by a user.

The information provision host 410 includes: a data storage unit 411 that stores push service information; a host communication unit 412 that exchanges push service information; and a host processing unit 413 that controls these units. When push service information is updated, the host processing unit 413 acquires the push service information updated by the host communication unit 412 and delivers the push service information to the communication network 420. The communication network 420 includes: an access server 422 that transmits push service information to the information acquisition terminal 430; and multiple wireless base stations 421 that are connected to the access server via wired lines. The communication network 420 transmits push service information delivered via the wireless base station 421 to the information acquisition terminal 430.

The information acquisition terminal 430 includes: a terminal communication unit 431 that communicates data for push service information; out-of-service determination unit 432 that determines whether or not the terminal remains being out of wireless communication service; conversation determination unit 433 that determines whether or not the terminal continues carrying on a conversation; and a terminal processing unit 434 that controls these components.

The out-of-service determination unit 432 uses time keeping unit (not shown) to measure a time period after the information acquisition terminal 430 becomes incapable of wireless communication. When the disabled wireless communication continues for a specified time period or longer, the out-of-service determination unit 432 notifies the terminal processing unit 434 that the information acquisition terminal 430 remains out of wireless communication service. The specified time period is hereafter referred to as a continued out-of-service time. The conversation determination unit 433 uses the time keeping unit to measure a time period during which a channel connected to the communication network 420 is used for conversation. When the channel is continuously used for a specified time period or longer, the conversation determination unit 433 notifies the terminal processing unit 434 that the information acquisition terminal 430 continues carrying on a conversation. The specified time period is hereafter referred to as a continued conversation time.

The following describes information interchange between the elements (information provision host 410, communication network 420, and information acquisition terminal 430) of the push service system according to the embodiment with reference to the schematic diagram in FIG. 4 and a data communication flowchart in FIG. 5. The description below uses reference numerals in FIGS. 4 and 5 when needed.

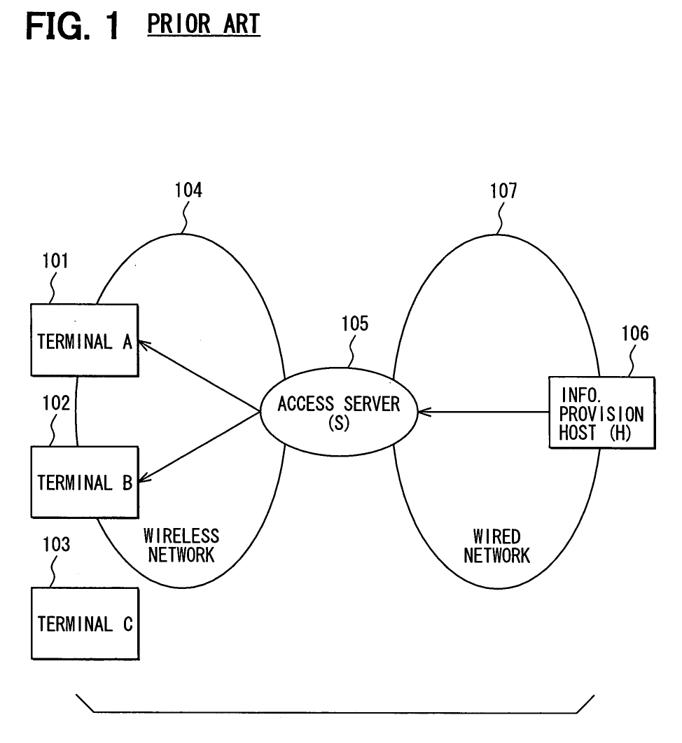

The invention is characterized by the way of interchanging push service information when a push service is provided while the information acquisition terminal 430 is out of wireless communication service or is carrying on a conversation. The construction of the push service system 400 up to the stage of delivering push service information conforms to the technology described in “Description of Related Art” with reference to FIG. 1. The push service according to the embodiment premises SMS (Short Message Service). The push service information is equivalent to a short message, i.e., character data containing the limited number of characters. The short message is hereafter referred to as an SMS. In more detail, the SMS includes current information such as news needed by users, information (hereafter referred to as maintenance information) about limitation on the use of the push service system for its improvement and repair, information (hereafter referred to as security information) from the information provision host for keeping track of a terminal when it is stolen, and emergency information such as disaster information.

The information acquisition terminal 430 complies with a communication system other than the multi-call system such as W-CDMA capable of simultaneously processing data communication and conversation.

The flowchart in FIG. 5 assumes a situation where the information provision host delivers an SMS while the information acquisition terminal 430 is not on standby (out of wireless communication service or during a voice call). In FIG. 5, a hundred's digit of a number assigned to each step corresponds to the element of the system. The step indicates an operation for the corresponding element. Digit 1 corresponds to the information provision host 410. Digit 2 corresponds to the communication network 420. Digit 3 corresponds to the information acquisition terminal 430.

Updating an SMS maintained in the information provision host 410 starts the flowchart (Step 5100). The information provision host 410 transmits the SMS to the information acquisition terminal 430. For this purpose, the information provision host 410 requests the intermediate communication network 420 to transmit the SMS to the information acquisition terminal 430 and transmits the requested SMS to the communication network 420 (Step 5110).

The communication network 420 transmits the SMS to the information acquisition terminal 430 (Step 5200). The push service system 400 proceeds to Step 5300. At Step 5300, the system determines whether or not the information acquisition terminal 430 is on standby. When the information acquisition terminal 430 is on standby (yes at Step 5300), the system proceeds to Step 5310. When the information acquisition terminal 430 is out of wireless communication service or is carrying on a conversation (no at Step 5300), the system measures a time period when the out-of-service determination unit 432 becomes out of wireless communication service or the conversation determination unit 433 becomes busy (Step 5301). The system then proceeds to Step 5210. As mentioned above, the initial state of the flowchart assumes that the information acquisition terminal 430 is out of wireless communication service or is carrying on a conversation. It should be noted that the system starts measuring the time period at Step 5301 under the condition of being out of wireless communication service or being busy and continues the measurement.

The following describes in more detail the process when Step 5300 results in the affirmative (yes). In this case, the push service system 400 proceeds to Step 5310. At Step 5310, it is determined whether or not to request transmission of the SMS when the information acquisition terminal 430 restores the standby state from the state being out of wireless communication service or the conversation state. More specifically, let us suppose that the information acquisition terminal 430 restores the standby state from the state being out of wireless communication service. When the time period measured by the out-of-service determination unit 432 is shorter than or equal to the continued out-of-service time (yes at Step 5310), the system proceeds to Step 5320. This is because the information acquisition terminal 430 can receive the retransmitted SMS from the communication network 420. When the measured time period exceeds the continued out-of-service time (no at Step 5310), it is clear that the communication network 420 retransmits no SMS. This is because the continued out-of-service time matches the time to retransmit the SMS from the communication network 420. In this case, the information acquisition terminal 430 issues a request for transmitting the SMS to the information provision host 410 via the communication network 420 (Step 5340).

When the information acquisition terminal 430 restores the standby state from the conversation state, the system follows a process flow similar to the above-mentioned one based on the measured time period.

At Step 5320, it is determined whether or not the information acquisition terminal 430 receives the SMS retransmitted from the communication network 420. When the information acquisition terminal 430 receives the SMS (yes at Step 5320), the system proceeds to Step 5330. The information acquisition terminal 430 transmits an acknowledgment signal (hereafter referred to as an ACK signal) to the communication network 420 in Step 5330. This signal indicates that the information acquisition terminal 430 has received the SMS. The communication network 430 then proceeds to Step 5210.

When Step 5320 results in the negative (no), the system proceeds to Step 5210. This is because the information acquisition terminal 430 can receive the retransmitted SMS from the communication network 420.

The following describes in more detail the process when Step 5300 results in the negative (no), i.e., at Step 5210 and later. At Step 5210, the system determines whether or not the communication network 420 receives the ACK signal for notifying completion of the SMS reception from the information acquisition terminal 430. When the ACK signal is received (yes at Step 5210), the SMS is successfully transmitted to the information acquisition terminal 430. The communication network 420 notifies the information provision host 410 of the successfully SMS transmission (Step 5220). The information provision host 410 deletes the corresponding SMS from the data storage unit 411 (Step 5120). The system terminates a sequence of push service transmission (Step 5130).

When the communication network 420 does not receive the ACK signal at Step 5210 (no at Step 5210), the communication network 420 proceeds to the retransmission of the SMS at Step 5230 and later. The communication network 420 measures a time period elapsed from the time when the first SMS is transmitted to the information acquisition terminal 430. When the time period is within a predetermined retransmission time (no at Step 5230), the communication network 420 periodically transmits the SMS to the information acquisition terminal 430. When the measured time period exceeds the retransmission time (yes at Step 5230), the communication network 420 determines that the retransmission fails. The communication network 420 notifies the information provision host 410 of unsuccessful transmission of the SMS (Step 5240).

The information provision host 410 stores the corresponding SMS in the data storage unit and settles an expiration date for the SMS from that time point (Step 5140). The expiration date is settled for the SMS because the information may become useless for the user after a specified time period. For example, the current information such as discounts on merchandise and today's news is limited to the same date and will be meaningless when it is retransmitted the next day. In this case, the expiration date is settled to the same day. On the other hand, for example, maintenance information needs to be notified as long as possible. The expiration date is settled to be long at least until the maintenance period expires. The expiration date may not be settled for such SMS as related to security or emergency information that needs to be notified reliably. In this case, the SMS is recorded until it is transmitted successfully or the user manually cancels the retransmission.

Since the expiration date is settled to manage the SMS, it is possible to prevent an unnecessary SMS from being transmitted to the user and decrease an accompanying communication traffic.

When the expiration date has passed (no at Step 5150), the SMS is meaningless to the user as mentioned above. The information provision host 410 deletes the corresponding SMS (Step 5120) and terminates the process (Step 5130).

When the expiration date takes effect (yes at Step 5150), the SMS is useful for the user. The information provision host 410 makes the SMS ready for retransmission and keeps it stored in the data storage unit 411 (Step 5160). Retransmission of the SMS is triggered when the information provision host 410 receives the SMS transmission request transmitted from the information acquisition terminal 430 at Step 5340 (yes at Step 5160). When the SMS transmission request is not received (no at Step 5160), the information provision host 410 manages the expiration date for the SMS (Step 5150).

Although the present invention has been fully described in connection with the preferred embodiment thereof with reference to the accompanying drawings, it is to be noted that various changes and modifications will become apparent to those skilled in the art.

For example, the terminal 430 may be a radio installed on a vehicle or the like. In this case, the terminal 430 on, for example, a stolen car may be traced by using GPS system, and the position of the car may be reported to a police or the like. The vehicle might be moved to an area where the wireless communication is out of service, tracking of the vehicle may be resumed as soon as the vehicle moves back to the service area by using SMS.

Because the continued out-of-service time used in Step 5130 (or the continued out-of-service/busy time) is matched with the time for re-transmission of SMS from the server 420, the re-transmission of SMS may be received by the terminal 430 when the terminal 430 returns to a waiting condition or returns to in-service area while SMS is re-transmitted. That is, a condition that the terminal 430 can not receive the re-transmitted SMS due to the SMS re-transmission time being shorter than the continued out-of-service time is prevented. In this case, the continued out-of-service time may only roughly match the time for SMS re-transmission for effectively preventing the above condition.

Further, the above operation scheme can prevent unnecessary SMS transmission request to the host 410, thereby preventing unnecessary transmission from the host 410. In this manner, the useless traffic in the push service system 400 is achieved.

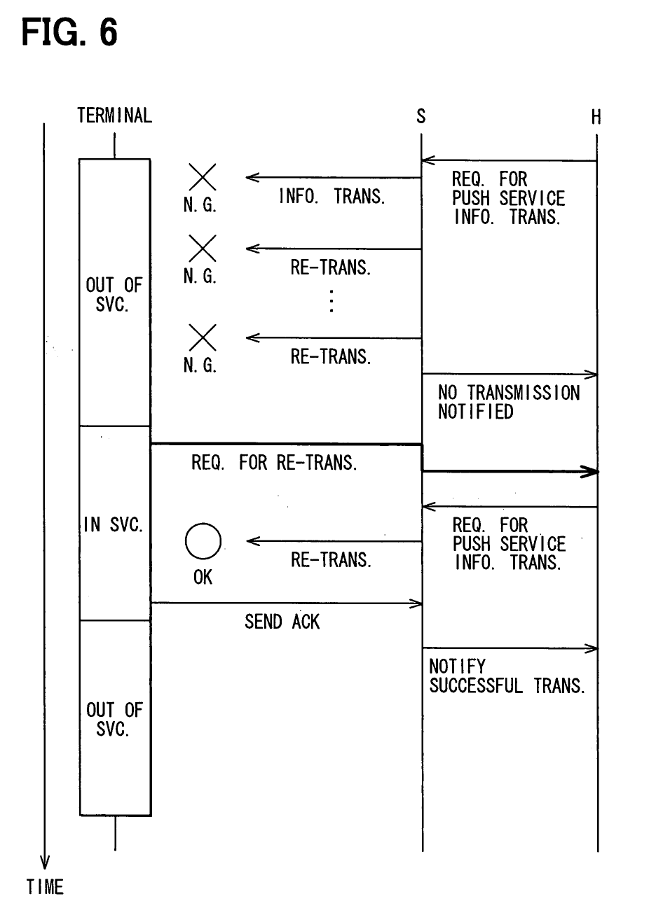

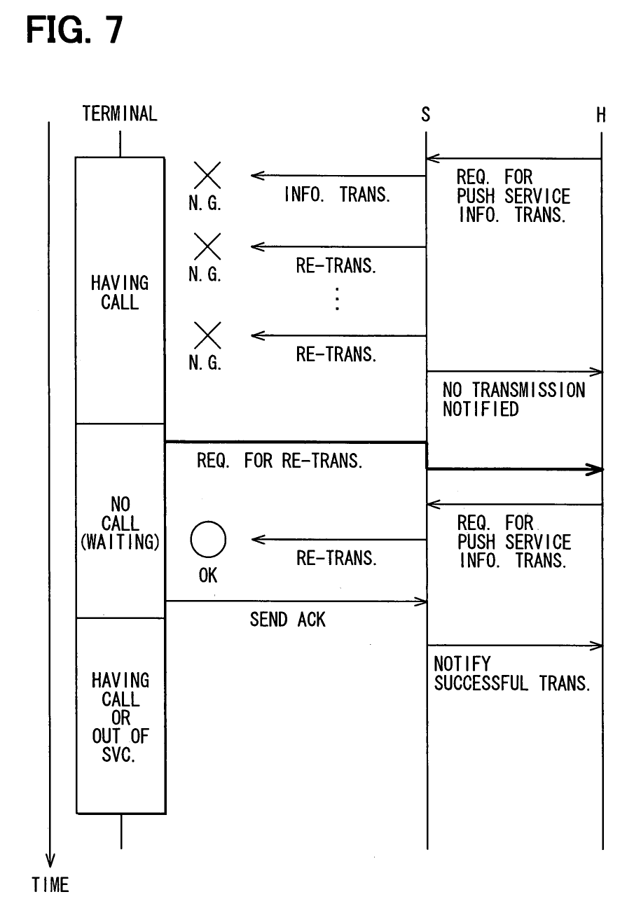

Furthermore, as shown in FIGS. 6 and 7, the terminal 430 sends the request for SMS transmission to the host 410 through the network 420 when the terminal 430 returns to the serviced condition or the busy condition after continued out-of-service time/busy time is longer than the set time. In this manner, the host 410 can send the SMS to the 430 with increased probability and without controlling re-transmission in the conventional manner.

Furthermore, the not-delivered SMS managed with expiration data makes it possible to eliminate reception of useless SMS by the terminal 430. In this manner, the terminal 430 can receive SMS being transmitted during the out-of-service/busy period as soon as possible after returning to the serviced condition.

Such changes and modifications are to be understood as being within the scope of the present invention as defined by the appended claims.

What is claimed is:

1. A push service system comprising:
a terminal for acquiring information when wireless communication is established between the terminal and a communication network; and
a host for providing information for the terminal regardless of a condition of wireless communication of the terminal,
wherein the terminal requests the host through the wireless communication to provide the information when the terminal resumes the wireless communication after a predetermined period of lack of wireless communication with the communication network.

2. The push service system as in claim 1 further comprising:
an out-of-service determination unit in the terminal for determining a continued condition of the lack of wireless communication with the communication network based on a measurement of a lapse time of the lack of wireless communication with the communication network,
wherein the terminal uses the measurement of the lapse time of the lack of wireless communication with the communication network as the predetermined period.

3. The push service system as in claim 2,
wherein, when the host provides the information during the lack of the wireless communication with the terminal, the communication network keeps transmission of the information to the terminal for a predetermined duration as long as the lack of the wireless communication continues,
the predetermined period is substantially same as the predetermined duration, and
the out-of-service determination unit measures the predetermined duration for use in determination.

4. An information terminal comprising:
a communication unit for having wireless communication with a communication network; and
a processing unit for processing information,
wherein information is provided from a host to the communication unit of the information terminal regardless of a condition of the wireless communication with the communication network, and
the communication unit requests the host through the wireless communication to provide the information for the communication unit when the wireless communication is resumed after a predetermined period of continuation of lack of wireless communication with the communication network.

5. The information terminal as in claim 4 further comprising:
an out-of-service determination unit in the terminal for determining continuation of the lack of wireless communication with the communication network based on a measurement of a lapse time of the lack of wireless communication with the communication network,
wherein the terminal uses the measurement of the lapse time of the lack of wireless communication with the communication network as the predetermined period.

6. A push service system comprising:
a terminal for acquiring information when wireless communication is established between the terminal and a communication network; and
a host for providing information for the terminal regardless of a condition of wireless communication of the terminal,
wherein the terminal includes an information acquisition unit for acquiring the information, a call unit for establishing a call with an other terminal, and a control unit for controlling the information acquisition unit and the communication unit,
the terminal does not allow parallel operation of the information acquisition unit and the call unit, and
the control unit triggers the information acquisition unit to transmit a request for information to the host through the wireless communication at an end of the call when the terminal is involved in the call by using the call unit for a period that is greater than a predetermined time.

7. The push service system as in claim 6 further comprising:
a call continuation determination unit for determining continuation of a call by measuring a call time,
wherein the call time measured by the call continuation determination unit is used as the predetermined time for determination of continuation of the call by the call continuation determination unit.

8. The push service system as in claim 7,
wherein, when the information is provided for the terminal that is being involved in a call with the other terminal, the wireless communication with the communication network keeps provision of the information from the host to the terminal for a set time as long as the call is being established between the terminal and the other terminal,
the predetermined time for determining continuation of the call and the set time is substantially same as the set time, and
the call continuation determination unit measures the set time for use in determination.

9. An information terminal comprising:
an information acquisition unit for acquiring information,
a call unit for establishing a call with an other terminal, and
a control unit for controlling the information acquisition unit and the communication unit,
wherein information is provided from a host to the information terminal through the wireless communication with a communication network regardless of a condition of the wireless communication with the communication network,
the terminal does not allow parallel operation of the information acquisition unit and the call unit, and
the control unit triggers the information acquisition unit to transmit a request for information to the host through the wireless communication at an end of the call when the terminal is involved in the call by using the call unit for a period that is greater than a predetermined time.

10. The information terminal as in claim 9 further comprising:
a call continuation determination unit for determining continuation of a call by measuring a call time,
wherein the call time measured by the call continuation determination unit is used as the predetermined time for determination of continuation of the call by the call continuation determination unit.

11. The information terminal as in claim 1,
wherein the host provides the information to the terminal only when the host has received a request for the information from the terminal.
